(19) United States
(12) Patent Application Publication
(10) Pub. No.: US 2017/0076904 A1
(43) Pub. Date: Mar. 16, 2017

(54) X-RAY TUBE

(71) Applicant: Toshiba Electron Tubes & Devices Co., Ltd., Otawara-shi (JP)

(72) Inventors: Toshio HANAKI, Sakura (JP); Katsunori SHIMIZU, Otawara (JP); Hidero ANNO, Otawara (JP)

(73) Assignee: Toshiba Electron Tubes & Devices Co., Ltd., Otawara-shi (JP)

(21) Appl. No.: 15/261,463

(22) Filed: Sep. 9, 2016

(30) Foreign Application Priority Data
Sep. 11, 2015 (JP) 2015-179571

(51) Int. Cl. H01J 35/16; H01J 35/04; H01J 35/18

(52) U.S. Cl. CPC H01J 35/16; H01J 35/18; H01J 35/04

(57) ABSTRACT

According to one embodiment, an X-ray tube includes an envelope including an inner space which is evacuated and is tightly closed and also including an X-ray radiation window, a cathode supporting member provided in the envelope, a cathode secured to the cathode supporting member, emitting electrons, and radiating heat, an anode target provided in the envelope, opposed to the X-ray radiation window, and radiating X-rays due to collision of the electrons emitted from the cathode, and a non-evaporable getter thermally connected to the cathode supporting member on the cathode side and activated by heat due to thermal conduction from the cathode supporting member.

### CROSS-REFERENCE TO RELATED APPLICATIONS

This application is based upon and claims the benefit of priority from Japanese Patent Application No. 2015-179571, filed Sep. 11, 2015, the entire contents of which are incorporated herein by reference.

### FIELD

Embodiments described herein relate generally to an X-ray tube comprising a non-evaporable getter.

### BACKGROUND

A conventional X-ray tube comprises an evaporable getter configured to adsorb gas to maintain a vacuum in the X-ray tube. The evaporable getter (flash getter) evaporates barium and deposits it as a vapor-deposited barium film on the surface of an element provided in a vacuum envelope. Since barium has a high saturated vapor pressure and tends to evaporate again at a relatively low temperature, an area for forming a vapor-deposited barium film is inevitably limited to such an area where the temperature is sufficiently low. However, such an area where the temperature is sufficiently low and there is no danger of an electrical insulating element losing its insulating properties by the vapor-deposited barium film is limited, and thus it is difficult to secure a sufficient surface area. Therefore, a vapor-deposited barium film having a sufficient gas adsorption capability cannot be formed.

In the meantime, there is a non-evaporable getter which does not use a vapor-deposited film. The non-evaporable getter is a porous block of a sintered material mainly containing finely-powdered zirconium. The porous block comprises a built-in heater, and the heater is supplied with predetermined electrical power from two electrical connection terminals which project outside of the getter and maintains the getter to have a predetermined temperature. In the operation of the X-ray tube, the non-evaporable getter adsorbs gas molecules. Since the non-evaporable getter does not use a vapor-deposited film, there is no danger of surrounding electrical insulating elements losing their insulation properties.

However, the non-evaporable getter requires an electrical connection path and an electrical connection terminal for electrical heating in the X-ray tube, and further requires a getter heating power supply, a getter heating power control unit and the like in an X-ray apparatus equipped with the X-ray tube. Therefore, to provide the X-ray tube or the X-ray apparatus equipped with the X-ray tube inexpensively, the non-evaporable getter has a serious disadvantage.

To overcome this disadvantage, an embodiment aims to provide an X-ray tube which can stably maintain a vacuum inexpensively.

### BRIEF DESCRIPTION OF THE DRAWINGS

FIG. 1 is a sectional view of an example of an X-ray tube of a first embodiment.

FIG. 2 is a schematic view of an attachment member for a non-evaporable getter of the first embodiment.

FIG. 3A is an enlarged sectional view of the X-ray tube of the first embodiment.

FIG. 3B is an enlarged sectional view of the X-ray tube of the first embodiment.

FIG. 4A is an enlarged sectional view of a modification of the X-ray tube of the first embodiment.

FIG. 4B is an enlarged sectional view of a modification of the X-ray tube of the first embodiment.

FIG. 5A is an enlarged sectional view of an X-ray tube of a second embodiment.

FIG. 5B is an enlarged sectional view of an X-ray tube of a second embodiment.

FIG. 6A is an enlarged sectional view of a modification of the X-ray tube of the second embodiment.

FIG. 6B is an enlarged sectional view of a modification of the X-ray tube of the second embodiment.

FIG. 7A is an enlarged sectional view of another modification of the X-ray tube of the second embodiment.

FIG. 7B is an enlarged sectional view of another modification of the X-ray tube of the second embodiment.

### DETAILED DESCRIPTION

In general, according to one embodiment, an X-ray tube (100), characterized by comprises: an envelope (3, 4) comprising an inner space which is evacuated and is tightly closed and also comprising an X-ray radiation window which transmits X-rays to the outside;

a cathode supporting member (7) provided in the envelope; a cathode (1) secured to the cathode supporting member, emitting electrons due to supply of electrical current, and radiating heat; an anode target (2) provided in the envelope, opposed to the X-ray radiation window, and radiating X-rays due to collision of the electrons emitted from the cathode; and a non-evaporable getter (8) thermally connected to the cathode supporting member on the cathode side and activated by heat due to thermal conduction from the cathode supporting member heated by the radiant heat from the cathode.

An X-ray tube assembly of an embodiment will be described hereinafter with reference to the accompanying drawings.

### First Embodiment

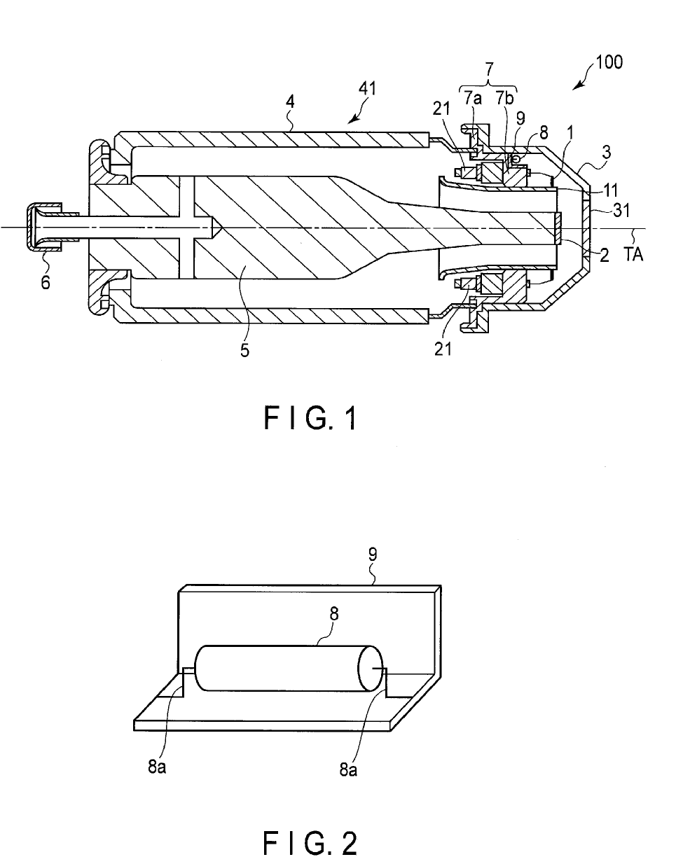

FIG. 1 is a sectional view of an example of an X-ray tube 100 of a first embodiment.

The X-ray tube 100 comprises a cathode 1, an anode target 2, a metal envelope 3 comprising an X-ray radiation window 31, an insulating envelope 4, an anode supporting member 5, an electric supply portion 6, a cathode supporting member 7, a non-evaporable getter 8, an attachment member 9, and a Wehnelt electrode 11. In the following, the center axis of the X-ray tube 100 is referred to as a tube axis TA. The X-ray tube 100 is, for example, a stationary anode X-ray tube.

In the X-ray tube 100 shown in FIG. 1, the directions of the tube axis TA are referred to as horizontal directions. In the horizontal directions, the direction away from the anode target 2 and toward the X-ray radiation window 31 is referred to as a forward direction and the opposite direction is referred to as a backward direction. Further, the directions perpendicular to the tube axis TA are referred to as radial directions. In the radial directions, the directions toward the tube axis TA are referred to as inward directions, and the directions away from the tube axis TA are referred to as outward directions.

The metal envelope 3 is a substantially cylindrical container having a base. The metal envelope 3 is formed of a metal material. The metal envelope 3 comprises an X-ray radiation window 31. The X-ray radiation window 31 is formed of an X-ray transmissive material such as beryllium (Be).

The insulating envelope 4 is a cylindrical container. The insulating envelope 4 is formed of an insulating material. As shown in FIG. 1, the metal envelope 3 and the insulating envelope 4 are attached to each other via the cathode supporting member 7 such that the opening of the metal envelope 3 and the opening of the insulating envelope 4 are opposed to each other.

In the following, the metal envelope 3 and the insulating envelope 4 may be collectively referred to as a vacuum envelope (envelope) 41.

The vacuum envelope 41 accommodates the cathode (cathode filament) 1, the anode target 2, the anode supporting member 5, the cathode supporting member 7, the non-evaporable getter 8, and the attachment member 9. In the vacuum envelope 41, a vacuum is maintained.

The cathode supporting member 7 is provided between the metal envelope 3 and the insulating envelope 4 and extends from the outside to the inside. In the cathode supporting member 7, a part of the outer periphery is assumed to be an outer periphery supporting member 7a, and a part of the inner periphery is assumed to be an inner periphery supporting member 7b. A part of the outer periphery supporting member 7a is vacuum tightly held between the metal envelope 3 and the insulating envelope 4. The inner periphery supporting member 7b extends from the inner wall of the metal envelope 3 to the inside. The inner periphery supporting member 7b has, for example, a substantially hollow disc shape. The inner periphery supporting member 7b comprises terminals 21 on the back side. The cathode supporting member 7 is formed of a metal material.

In the vacuum envelope 41, the Wehnelt electrode 11 having a substantially cylindrical shape is provided. The Wehnelt electrode 11 is in contact with the inner side of the inner periphery supporting member 7b.

The anode target 2 is secured to an edge of the anode supporting member 5 on the inside of the Wehnelt electrode 11. Here, the anode target 2 is on the same axis as the tube axis TA and is opposed to the X-ray radiation window 31.

The anode supporting member 5 has a substantially cylindrical shape. In a part of the anode supporting member 5, a path for evacuating gas in the X-ray tube 100 is formed. In the anode supporting member 5, an edge opposite to the edge to which the anode target 2 is secured is exposed to the outside of the vacuum envelope 41. The electric supply portion 6 is connected to this opposite edge of the anode supporting member 5. The electric supply portion 6 supplies power to apply a high positive voltage to the anode target 2.

The cathode (cathode filament) 1 is a ring-like filament. The cathode 1 is formed of, for example, tungsten (W). As electric power is supplied to the cathode 1, the cathode 1 emits electrons. As electric current flows in the cathode 1, the cathode 1 radiates heat. The cathode 1 is provided on the front side of the inner periphery supporting member 7b and on the outside of the Wehnelt electrode 11 such that the cathode 1 surrounds the periphery of the anode target 2. Here, the cathode 1 is supported by a several rods attached to a part of the front side surface of the inner periphery supporting member 7b. These support rods are formed of, for example, tungsten (W).

The non-evaporable getter 8 adsorbs gas molecules in the vacuum envelope 41. The non-evaporable getter 8 is, for example, a porous block of a sintered material mainly containing finely-powered zirconium. An electric heater is embedded in the porous block, and two legs (electric supply terminals) 8a project outside of the porous block. Here, such a getter with a built-in heater is used in a non-conducting state, that is, with no power supplying to the terminals 8a.

For example, as the non-evaporable getter 8, a heater-embedded non-evaporable getter St 171 or St 172 commercialized from SAES Getters Japan Co., Ltd., can be used. In the non-evaporable getter 8, as the temperature increases, and the surface is activated and the adsorbed gas is dispersed inside the non-evaporable getter 8. That is, in the non-evaporable getter 8, as the temperature increases, the gas adsorption capability is improved. In the non-evaporable getter 8, when the temperature is too low, the gas adsorption capability is degraded.

According to the non-evaporable getter 8, it is possible, by using heat radiated from the cathode 1, to activate the getter and maintain the getter function of continuously adsorbing gas. For example, the non-evaporable getter 8 is heated by thermal conduction from surrounding elements heated by the thermal radiation from the cathode 1. Therefore, the non-evaporable getter 8 is thermally connected to the front side of the inner periphery supporting member 7b which is subject to the thermal radiation from the cathode 1. Note that the non-evaporable getter 8 may be attached to the attachment member 9 which has a higher rate of thermal radiation (having a higher rate of temperature increase due to radiant heat) such that the non-evaporable getter 8 becomes more subject to the thermal radiation from the cathode 1.

An example of the arrangement of the non-evaporable getter 8 of the present embodiment will be described with reference to the accompanying drawings.

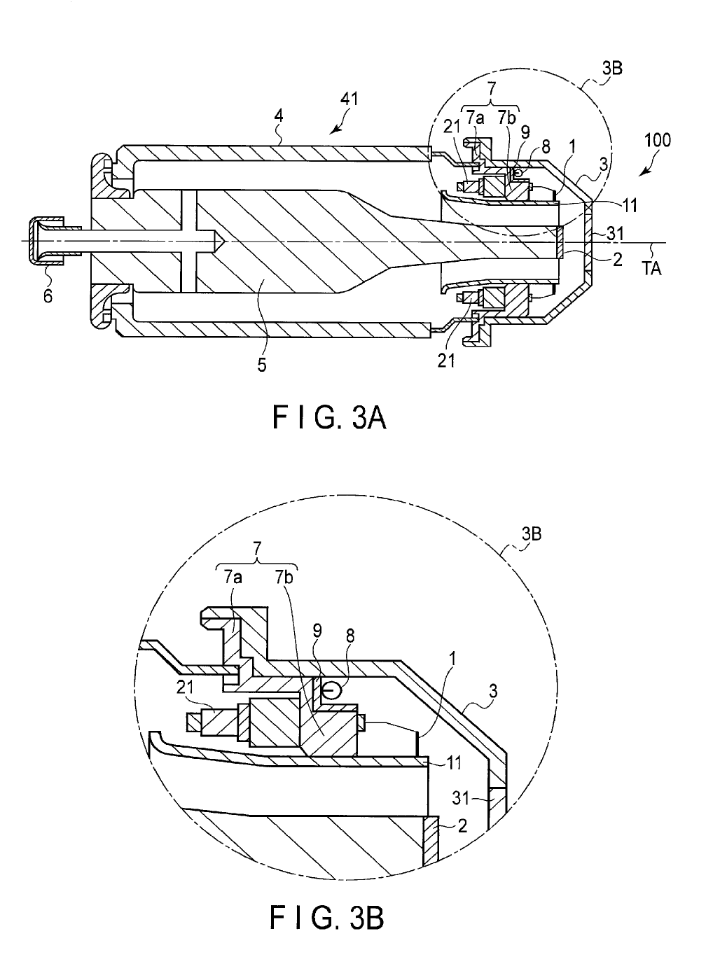

FIG. 2 is a schematic view of the attachment member 9 to which the non-evaporable getter 8 of the present embodiment is attached. FIGS. 3A and 3B are enlarged sectional views of the X-ray tube of the present embodiment.

The non-evaporable getter 8 comprises, for example, two legs (electric supply terminals) 8a as attachment portions to the attachment member 9, and these legs 8a are secured to the inner side surface of the attachment member 9 by means of welding or the like. These legs 8a are conductors and metal members.

The attachment member 9 is formed of a material having a high rate of thermal radiation. The attachment member 9 is heated by the radiant heat from the cathode 1. The heat transferred to the attachment member 9 is then transferred to the non-evaporable getter 8. For example, the attachment member 9 is formed of a material having a high rate of thermal radiation such as iron, steel (SUS) or ceramic. The attachment member 9 has, for example, an L-shape. Note that the attachment member 9 may have a U-shape (not shown) or may be a flat plate (not shown).

The inner periphery supporting member 7b comprises a forward-opening rectangular recess for installation of the attachment member 9 with the non-evaporable getter 8 attached thereto. The attachment member 9 with the non-evaporable getter 8 attached thereto is secured to the rectangular recess. For example, as shown in FIGS. 3A and 3B, the inner periphery supporting member 7b comprises a multilevel recess at the boundary with the inner wall of the metal envelope 3. The attachment member 9 with the non-evaporable getter 8 attached thereto is engaged with and secured to the multilevel recess.

According to the above-described arrangement example of the non-evaporable getter 8, it is possible to sufficiently heat and activate the non-evaporable getter 8 and thereby maintain the gas adsorption capability of the non-evaporable getter 8.

In the present embodiment, during the operation, the X-ray tube 100 applies a high positive voltage to the anode target 2. At this time, the metal envelope 3 and the Wehnelt electrode 11 are grounded. Under the influence of an electrical field of a high voltage produced by the anode target 2, the metal envelope 3 and the Wehnelt electrode 11, electrons are emitted from the cathode 1 and collide with the anode target 2. At this time, the inner periphery supporting member 7b is heated by the radiant heat from the cathode 1, and the temperature of the inner periphery supporting member 7b becomes high. For example, the inner periphery supporting member 7b has a temperature of 80 to 200° C. Further, the attachment member 9 is heated directly by the radiant heat from the cathode 1 and indirectly by the thermal conduction from the inner periphery supporting member 7b heated by the radiant heat from the cathode 1, and the temperature of the attachment member 9 becomes high. As the non-evaporable getter 8 is heated directly by the radiant heat from the cathode 1 and indirectly by the thermal conduction from the attachment member 9, the temperature of the non-evaporable getter 8 becomes high. As the temperature increases, the non-evaporable getter 8 is activated. Consequently, the non-evaporable getter 8 continuously adsorbs gas molecules and thereby maintains a vacuum in the vacuum envelope 41.

According to the present embodiment, it is possible, by arranging the non-evaporable getter 8 such that the non-evaporable getter 8 becomes subject to the radiant heat from the cathode 1, to activate the non-evaporable getter 8 efficiently without supplying electric power to the non-evaporable getter 8. Therefore, in the X-ray tube 100, a vacuum can be stably maintained inside, and possible electrical discharge associated with high voltage application can be prevented. As a result, a highly reliable X-ray tube can be realized.

Next, a modification of the X-ray tube of the first embodiment will be described. In the modification, elements the same as those of the above-described embodiment will be denoted by the same reference numbers, and detailed description thereof will be omitted.

### (Modification)

In an X-ray tube 100 of the modification, a non-evaporable getter 8 is directly installed in an inner periphery supporting member 7b.

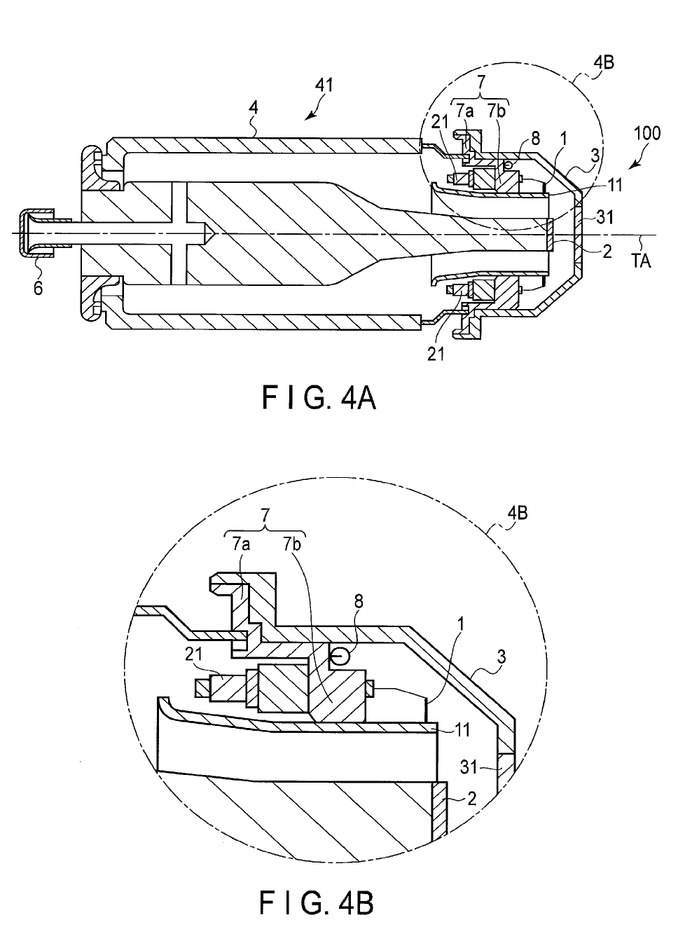

FIGS. 4A and 4B are enlarged sectional views of the X-ray tube 100 of the modification. In the X-ray tube 100 of the modification, the non-evaporable getter 8 is directly provided in a part of the inner periphery supporting member 7b. For example, as shown in FIGS. 4A and 4B, the inner periphery supporting member 7b comprises a forward-opening rectangular recess for the installation of the non-evaporable getter 8. Here, the inner periphery supporting member 7b is formed of a material having a high rate of thermal radiation such as iron or Stainless steel (SUS). The non-evaporable getter 8 is secured to the inner wall of this rectangular recess.

In the present embodiment, during the operation, the X-ray tube 100 applies a high positive voltage to an anode target 2. At this time, a metal envelope 3 and a Wehnelt electrode 11 are grounded. Under the influence of an electrical field of a high voltage produced by the anode target 2, the metal envelope 3 and the Wehnelt electrode 11, electrons are emitted from a cathode 1 and collide with the anode target 2. At this time, the inner periphery supporting member 7b is heated by the radiant heat from the cathode 1, and the temperature of the inner periphery supporting member 7b becomes high. For example, the inner periphery supporting member 7b has a temperature of 80 to 200° C. The non-evaporable getter 8 is heated directly by the radiant heat from the cathode 1 and indirectly by the thermal conduction from the inner periphery supporting member 7b heated by the radiant heat from the cathode 1, and the temperature of the non-evaporable getter 8 increases. As the temperature increases, the non-evaporable getter 8 is activated. Consequently, the non-evaporable getter 8 continuously adsorbs gas molecules and maintains a vacuum in a vacuum envelope 41.

According to the modification, even with fewer elements than that of the above-described embodiment, the X-ray tube 100 can efficiently activate the non-evaporable getter 8 without supplying electric power to the non-evaporable getter 8.

In the first embodiment and the modification of the first embodiment, although a getter with a built-in heater is used in a non-conducting state as the non-evaporable getter 8, a non-evaporable getter which is not provided with a built-in heater and is used in a non-conducting state may be used as the non-evaporable getter 8. In that case, if the non-evaporable getter has metal legs 8a similar to electric supply terminals, the non-evaporable getter may be assembled in a manner similar to that of the above-described embodiment. Further, if the non-evaporable getter does not have legs 8a, for example, the non-evaporable getter 8 may be held in several places with metal wires or the like.

In the first embodiment and the modification of the first embodiment, during the operation of the X-ray tube 100, evaporated materials (sputters) from the cathode 1 are attached to the non-evaporable getter 8, and thus the adsorption capability of the non-evaporable getter 8 is gradually degraded. However, contrary to the inventors' expectations, there is little negative impact of the reduction in the adsorption capability, and as compared to a conventional X-ray tube, a vacuum could be maintained more stably for a longer time.

Next, an X-ray tube assembly of another embodiment will be described. In the present embodiment, elements the same as those of the first embodiment will be denoted by the same reference numbers, and detailed description thereof will be omitted.

### Second Embodiment

An X-ray tube 100 of the second embodiment comprises a wall between a cathode 1 and a non-evaporable getter 8.

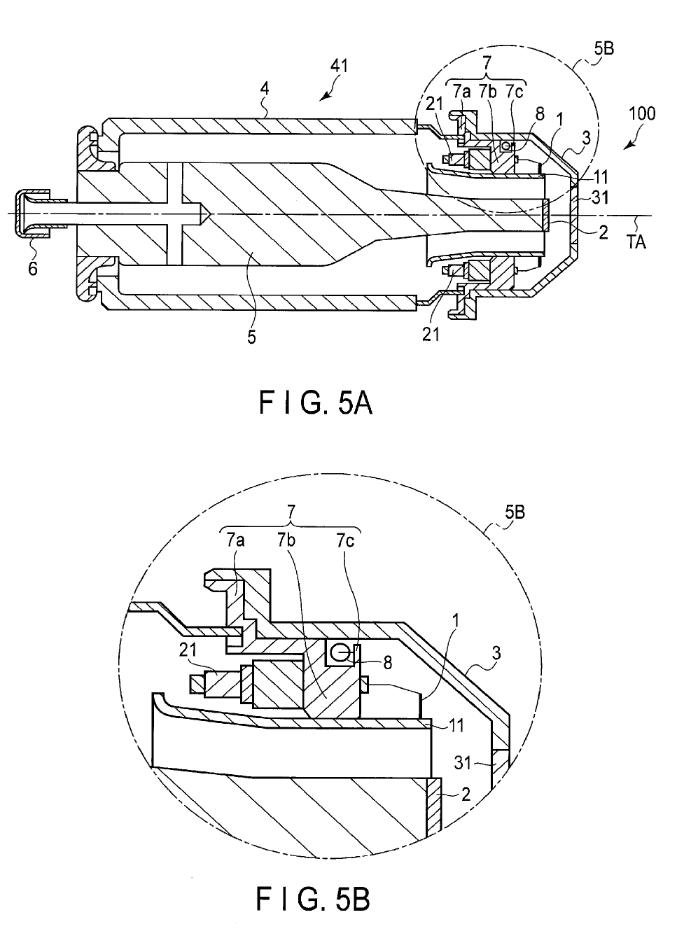

FIGS. 5A and 5B are enlarged views of the X-ray tube 100 of the second embodiment.

In the X-ray tube 100, to prevent attachment of evaporated materials (spatters) from the cathode 1 to the non-evaporable getter 8 during the operation, the wall is provided between the cathode 1 and the non-evaporable getter 8.

For example, as shown in FIGS. 5A and 5B, an inner peripheral supporting member 7b comprises an outward-opening rectangular recess. The non-evaporable getter 8 is secured to the inner wall of the recess of the inner periphery supporting member 7b. Here, the inner periphery supporting member 7b comprises a wall 7c having a predetermined thickness in a direction parallel to the tube axis TA between the cathode 1 and the non-evaporable getter 8. In the wall 7c, the inner periphery supporting member 7b comprises an opening which opens to the front space where the cathode 1 is provided. The inner periphery support 7b is formed of a material having a high rate of thermal radiation such as iron or Stainless steel (SUS).

According to the present embodiment, during the operation of the X-ray tube 100, it is possible to activate the non-evaporable getter 8 efficiently without supplying electric power to the non-evaporable getter 8 by arranging the non-evaporable getter 8 such that the non-evaporable getter 8 becomes subject to the radiant heat from the cathode 1, and it is also possible to prevent attachment of sputters from the cathode 1 to the non-evaporable getter 8. As a result, the X-ray tube 100 can maintain the gas adsorption capability of the non-evaporable getter 8 for a longer time than that of the above-described embodiment.

### (Modification)

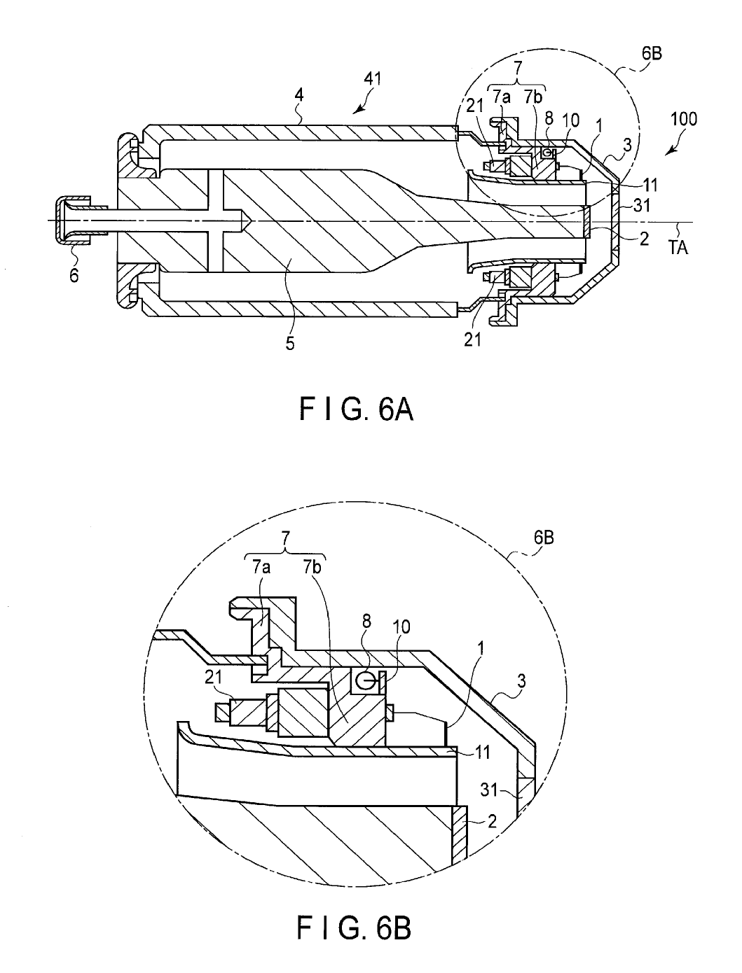

Note that, although the wall 7c is assumed to be a part of the inner periphery supporting member 7b (cathode supporting member 7) in the second embodiment, but the wall 7c may be provided as a separate member from the inner periphery supporting member 7b. For example, as shown in FIGS. 6A and 6B, a plate-like wall member (wall) 10 may be provided in place of the wall 7c of the second embodiment. The non-evaporable getter 8 is secured to a surface of the wall member 10. The wall member 10 with the non-evaporable getter 8 attached thereto is installed such that the non-evaporable getter 8 is inserted in the recess of the inner periphery supporting member 7b.

Next, another modification of the X-ray tube of the second embodiment will be described. In the modification, elements the same as those of the above-described embodiment will be denoted by the same reference numbers, and detailed description thereof will be omitted.

### (Modification)

An X-ray tube 100 of the modification differs in the installation position of the non-evaporable getter 8.

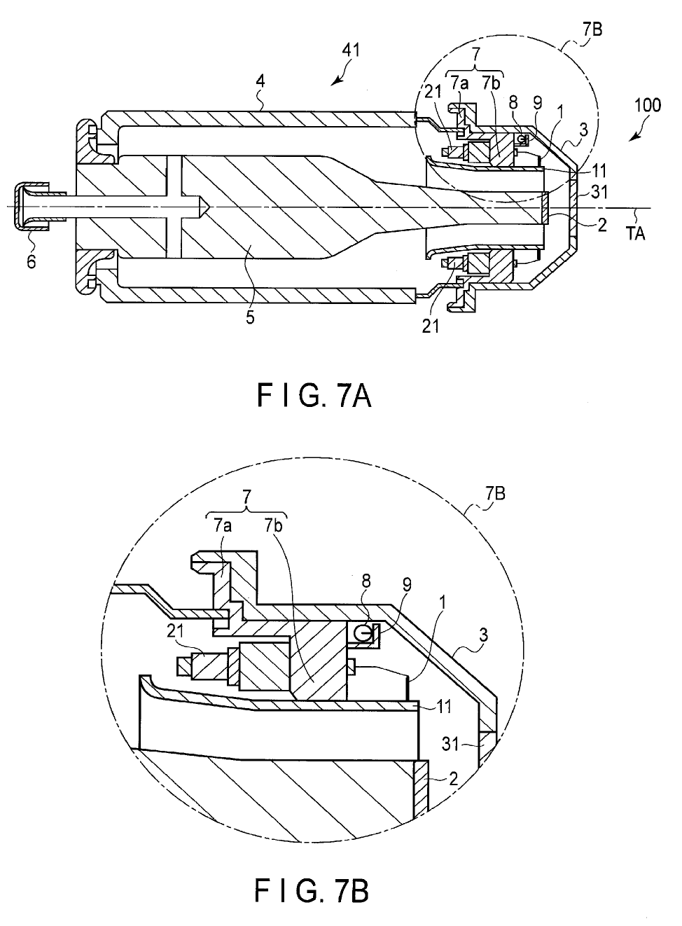

FIGS. 7A and 7B are enlarged sectional views of the second modification of the X-ray tube 100 of the second embodiment.

In the X-ray tube 100 of the modification, a non-evaporable getter 8 is secured to an attachment member 9. The attachment member 9 is provided on the front side of the inner periphery supporting member 7b such that the attachment member 9 is located between the cathode 1 and the non-evaporable getter 8. For example, as shown in FIGS. 7A and 7B, the attachment member 9 has an L-shape and is arranged such that one edge of the L-shape is secured to a front side surface of the inner periphery supporting member 7b and the other edge of the L-shape is opposed to an inner wall of a metal envelope 3.

According to the modification, as compared to the X-ray tube 100 of the second embodiment, the X-ray tube 100 can activate the non-evaporable getter 8 by thermal radiation from the cathode 1 and can prevent attachment of sputters from the cathode 1 to the non-evaporable getter 8 without any new additional manufacturing process to the inner periphery supporting member 7b.

In the second embodiment and the modifications of the second embodiment, a getter with a built-in heater is used in a non-conducting state as the non-evaporable getter 8, and the legs (electric supply terminals) 8a are secured to the wall (7c, 10 or 9) by means of welding, but the non-evaporable getter 8 can be interposed and secured between the inner periphery supporting member 7b and the wall (7c, 10 or 9).

In the second embodiment and the modifications of the second embodiment, a getter with a built-in heater is used in a non-conducting state as the non-evaporable getter 8, but a non-evaporable getter which is not provided with a built-in heater and is used in a non-conducting state may be used as the non-evaporable getter 8. In that case, if the non-evaporable getter has metal legs 8a similar to electrical connection terminals, the non-evaporable getter may be assembled in a manner similar to that of the above-described embodiment. Further, if the non-evaporable getter does not have legs 8a, for example, the non-evaporable getter 8 may be interposed and secured between the inner periphery supporting member 7b and the wall (7c, 10 or 9).

Note that, although the X-ray tube 100 has been assumed to be a stationary anode X-ray tube in the embodiments, the X-ray tube 100 may be a rotating anode X-ray tube.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray tube, comprising:
an envelope comprising an inner space which is evacuated and is tightly closed and also comprising an X-ray radiation window which transmits X-rays to the outside;
a cathode supporting member provided in the envelope;
a cathode secured to the cathode supporting member, emitting electrons due to supply of electrical current, and radiating heat;
an anode target provided in the envelope, opposed to the X-ray radiation window, and radiating X-rays due to collision of the electrons emitted from the cathode; and
a non-evaporable getter thermally connected to the cathode supporting member on the cathode side and activated by heat due to thermal conduction from the cathode supporting member heated by the radiant heat from the cathode.

2. The X-ray tube of claim 1, wherein the non-evaporable getter is embedded with an electric heater and is provided in the envelope in a non-conducting state.

3. The X-ray tube of claim 1, wherein the non-evaporable getter is provided in a recess formed in the cathode supporting member on the cathode side.

4. The X-ray tube of claim 1, further comprising an attachment member which is formed of a material having a high rate of thermal radiation and is provided in a part of the cathode supporting member on the cathode side together with the non-evaporable getter attached to the attachment member.

5. The X-ray tube of claim 1, further comprising a wall which is provided between the cathode and the non-evaporable getter.

6. The X-ray tube of claim 4, wherein the attachment member is provided such that the attachment member is located between the non-evaporable getter and the cathode.

7. The X-ray tube of claim 1, wherein the cathode supporting member is formed of a material having a high rate of thermal radiation.

8. The X-ray tube of claim 4, wherein the attachment member is iron, SUS or ceramic.

9. The X-ray tube of claim 7, wherein the cathode supporting member is iron or Stainless steel.
